(19) United States
(12) Patent Application Publication
(10) Pub. No.: US 2012/0318551 A1
(43) Pub. Date: Dec. 20, 2012

(54) Hand-Power Tool Comprising an Oscillation-Damping Device

(75) Inventors: Axel Kuhnle, Freiberg A.N. (DE); Matthias Tauber, Bad Boll (DE); Juergen Bochert, Stuttgart (DE); Carsten Diem, Ludwigsburg (DE); Willy Braun, Neustetten (DE); Christian Wiedemann, Wiernsheim (DE); Joerg Kaiser, Schwieberdingen (DE); Patrick Heinen, Ludwigsburg (DE); Roger Hahn, Neuhausen (DE); Thomas Speda, Holzgerlingen (DE)

(73) Assignee: Robert Bosch GmbH, Stuttgart (DE)

(21) Appl. No.: 13/515,788

(22) PCT Filed: Oct. 22, 2010
(86) PCT No.: PCT/EP2010/065979

§ 371 Date: Aug. 28, 2012

(30) Foreign Application Priority Data
Dec. 16, 2009 (DE) 10 2009 054 723.1

(51) Int. Cl. B25F 5/00; B25D 17/24

(52) U.S. Cl. 173/162.2

(57) ABSTRACT

A hand-power tool includes at least one oscillation-damping device that has at least one damping spring and a damping mass. The hand-power tool also includes a drive mechanism and a mechanism housing. The mechanism housing has a housing cover which is provided for closing a chamber in which the drive mechanism lies, and the housing cover has at least one fixing mechanism that at least partially fixes the oscillation-damping device in at least one operating state.

### PRIOR ART

The invention is based on a hand power tool as claimed in the preamble of claim 1.

Already known from EP 1 736 283 A2 is a hand power tool comprising at least one vibration absorber device, which has at least one absorber spring and an absorber mass, and comprising a drive mechanism and a mechanism housing.

### DISCLOSURE OF THE INVENTION

The invention is based on a hand power tool comprising at least one vibration absorber device, which has at least one absorber spring and an absorber mass, and comprising a drive mechanism and a mechanism housing.

It is proposed that the mechanism housing has a housing cover that is provided to close a chamber in which the drive mechanism is disposed and that has at least one fastening means that, in at least one operating state, at least partially fastens the vibration absorber device. In particular, a “hand power tool” is to be understood to include all hand power tools considered appropriate by persons skilled in the art, such as, in particular, percussion drills, demolition hammers, rotary hammers, percussion hammers, rotary percussion screwdrivers and/or, advantageously, rotary and/or chipping hammers. A “vibration absorber device” is to be understood to be, in particular, a device that in at least one operating state generates, upon a hand power tool machine housing and/or upon the mechanism housing and, in particular, upon at least a handle of the hand power tool, a force that counteracts a vibration, in particular of the hand power tool housing. The vibration absorber device thereby advantageously enables the hand power tool to be operated with little vibration. Preferably, the vibration absorber device operates passively, i.e. without an energy supply, apart from the vibration energy. In particular, the term “absorber spring” is to be understood to be a spring provided to transfer to the absorber mass, in particular directly, a force that accelerates and/or retards the absorber mass. Advantageously, the absorber spring is realized as a helical compression spring. Alternatively or additionally, the absorber spring could have a rectangular cross section perpendicularly in relation to a spring direction, or a plurality of absorber springs could be disposed in an interleaved manner and/or coaxially. Likewise alternatively or additionally, the absorber spring could be realized as a different torsion, spiral, tension and/or gas spring considered appropriate by persons skilled in the art. An “absorber mass” is to be understood to be, in particular, a unit provided to reduce the vibration, in particular of the hand power tool housing, through an inertia by means of an acceleration force and/or a retardation force, in that, advantageously, it vibrates with an angle of phase displacement in relation to the hand power tool housing. In particular, a “drive mechanism” is to be understood to be a mechanism that converts a motion of a drive motor into a work motion, in particular a percussive motion. A “mechanism housing” is to be understood to be, in particular, a housing in which at least the drive mechanism is disposed in a protected manner. Advantageously, the mechanism housing is realized so as to be at least partially integral with the hand power tool housing. Advantageously, the mechanism housing is provided to remove bearing forces, at least of the drive mechanism. A “housing cover” is to be understood to be, in particular, an element of the mechanism housing that is realized so as to be non-destructively separable from another element of the mechanism housing, in particular a housing shell. Preferably, the housing cover is provided to close an opening in the other element of the mechanism housing, in particular an opening provided for mounting the drive mechanism. Advantageously, the housing cover is free of bearing forces of the drive mechanism. Particularly advantageously, the housing cover transfers, in particular, mainly forces of the vibration absorber device and, in particular, forces that act upon the bearing cover from outside. “Provided” is to be understood to mean, in particular, specially equipped and/or designed. In particular, the term “close” is to be understood to mean that the housing cover covers over an opening of the other element of the mechanism housing, in particular a housing shell, when in a state of operational readiness. The housing cover thereby protects the chamber against soiling, i.e. it prevents dirt and, in particular, dust from entering through the opening to the drive mechanism. A “fastening means” is to be understood to be, in particular, a means provided to effect upon the vibration absorber device a force that immovably fastens at least one element of the vibration absorber device, preferably a holding part, relative to the mounted housing cover. Advantageously, the fastening means is realized so as to be at least partially integral with the housing cover. The fastening means is realized as a groove, as part of a screwed connection, as part of a latched connection and/or as part of another connection considered appropriate by persons skilled in the art. The design according to the invention makes it possible to achieve, with a simple structure, a particularly robust, compact and inexpensive hand power tool that can be operated with particularly little vibration. In particular, dispensing with an additional absorber cover makes it possible to achieve a particularly light hand power tool having an effective dissipation of heat from the drive mechanism.

In a further design, it is proposed that the vibration absorber device and the drive mechanism are disposed in the chamber closed by the housing cover, i.e. the vibration absorber device is disposed on an inner side of the housing cover. Advantageously, the chamber is realized as a grease chamber of the hand power tool. Since the vibration absorber device is disposed in the chamber, it is protected, in a structurally simple and particularly advantageous manner, against external influences such as dirt and mechanical damage. Further, the vibration absorber device can be lubricated, together with the drive mechanism, in a non-elaborate manner, such that there is little wear and good utilization of lubricant can be achieved. In addition, the vibration absorber device is rapidly heated by the drive mechanism, for example after a cold start, thereby further reducing wear and rendering possible a very constant characteristic frequency of the vibration absorber device.

Furthermore, it is proposed that the housing cover and the vibration absorber device constitute a structural unit that can be preassembled, such that assembly is advantageously non-elaborate. The expression “constitute a structural unit that can be preassembled” is to be understood to mean, in particular, that the housing cover and the vibration absorber device can be fixedly connected to each other in an assembly operation, in particular before the housing cover is fastened to the mechanism housing. As a result, the housing cover and the vibration absorber device can be connected to form a mountable unit. Advantageously, the housing cover and the vibration absorber device can be connected to each other such that they can be mounted jointly. Particularly advantageously, the housing cover and the vibration absorber device can be connected to each other such that they can transfer the acceleration force and/or a counter force of the acceleration force.

Further, it is proposed that at least the absorber spring, in at least one operating state, effects a fastening force upon the housing cover, enabling assembly to be achieved in a particularly non-elaborate manner. In particular, the expression “effect a fastening force” is to be understood to mean that the absorber spring exerts upon the housing cover a force that counteracts a motion of at least a part of the vibration absorber device. Advantageously, the fastening force counteracts a motion of a holding part of the vibration absorber device. Preferably, the fastening force prevents a motion of the holding parts.

In addition, it is proposed that the drive mechanism has a percussion mechanism, wherein the percussion mechanism and the vibration absorber device are at least partially disposed on at least one same plane that is aligned perpendicularly in relation to a spring direction, thereby making it possible to achieve a particularly effective vibration damping and, advantageously, good thermal coupling between the percussion mechanism and the vibration absorber device, and an advantageous utilization of space. A “percussion mechanism” is to be understood to be, in particular, a device that converts a rotary motion, in particular of the drive motor, into a linear percussive motion. Advantageously, the percussion mechanism is realized as a hammer percussion mechanism. Alternatively, the percussion mechanism could be realized as a ratchet percussion mechanism or as another percussion mechanism considered appropriate by persons skilled in the art. In particular, the expression, “at least partially disposed on a plane” is to be understood to mean that the plane intersects the percussion mechanism. A “spring direction” is to be understood to be, in particular, at least one direction in which the absorber spring must be loaded so as to be most able to elastically store energy. Advantageously, the absorber spring is realized so as to be elastically deformable in a spring direction by at least 25% of a length in a non-loaded state. Advantageously, the vibration absorber device at least partially encloses the percussion mechanism. This means that the vibration absorber device surrounds at least a point of the percussion mechanism on a plane by more than 180 degrees.

Furthermore, it is proposed that the vibration absorber device has at least one first and one second holding part, wherein the first holding part and the second holding part are supported against each other through the absorber spring, such that the structural space required is particularly small, and an advantageously rectilinear flux of force can be achieved. A “holding part” is to be understood to be, in particular, an element of the vibration absorber device that, in a mounted operating state, is connected to the housing cover so as to be immovable relative to the housing cover. Advantageously, forces resulting from an acceleration are transferred by the holding part from the absorber spring to the housing cover. Preferably, the holding part and the absorber spring are directly connected to each other. In particular, the holding part is a component realized so as to be separate from the mechanism housing and, preferably, from a housing cover. Advantageously, the holding part, when in a mounted operating state, exerts a force upon at least one element of a drive mechanism. In particular, the expression “through the absorber spring” is to be understood to mean that the absorber spring, as viewed in the spring direction, completely encloses the holding part. In this case, the holding part and the region of the spring that encloses the holding part are at least partially disposed on one same plane that is aligned perpendicularly in relation to the spring direction. “Bear against each other” is to be understood to mean, in particular, that the first and the second holding part are connected to each other so as to be immovable relative to each other during operation. Preferably, the second holding part bears in an inelastic manner exclusively on the first holding part, i.e., in particular, the second holding part is unconnected to the transmission housing.

In an advantageous realization of the invention, it is proposed that the vibration absorber device has at least one holding part and has at least one spring receiver that, in at least one operating state, exerts an acceleration force upon the absorber mass and, in at least one operating state, supports a counter force of the acceleration force on the holding part, making it possible to achieve a particularly small structural space requirement and low costs. Advantageously, the spring receiver exerts the acceleration force at one instant and, at another instant, supports the counter force. A “spring receiver” is to be understood to be, in particular, an element of the vibration absorber device that is disposed in a flux of force between the absorber spring and the absorber mass. Advantageously, the spring receiver is connected to the absorber mass in a mechanically fixed manner. Preferably, the spring receiver is movable relative to the mechanism housing. In particular, an “acceleration force” is to be understood to be a force that accelerates and/or retards the absorber mass. A “counter force” is to be understood to be, in particular, a force that supports the absorber spring on one side when another side of the absorber spring exerts the acceleration force upon the absorber mass.

In a further design, it is proposed that the vibration absorber device has at least one support element that, in at least one operating state, presses the spring receiver against the absorber spring, making it possible to achieve a particularly non-elaborate design, as well as an advantageous spring characteristic of the vibration absorber device and an advantageous tolerance compensation. In particular, it is possible to dispense with a positive, integral and/or frictional connection between the spring receiver and the absorber mass. A “support element” is to be understood to be, in particular, an element that, in at least one operating state, effects upon the spring receiver a force that counteracts a force that is effected by the absorber spring upon the spring receiver. Advantageously, the support element is realized as a cylindrical compression spring, as an elastomer part, as a zigzag or disk spring, and/or as another element considered appropriate by persons skilled in the art. Preferably, the force of the support element upon the spring receiver, in at least one operating state, is always significantly less, advantageously, than a force of the absorber spring on the same spring receiver. “Significantly less” in this context is to be understood to mean, in particular, less than 50%, advantageously less than 25%, particularly advantageously less than 10% of the force of the absorber spring. Alternatively, it would also be possible to dispense with support elements in the vibration absorber device.

Furthermore, it is proposed that the absorber spring is disposed entirely in an axial region of the absorber mass, thereby making it possible to achieve an advantageously small structural length in the spring direction. An “axial region of the absorber mass” is to be understood to be, in particular, a region delimited by two planes that are aligned perpendicularly in relation to the spring direction and that intersect the absorber mass.

### DRAWING

Further advantages are given by the following description of the drawing. Four exemplary embodiments of the invention are represented in the drawing. The drawing, the description and the claims contain numerous features in combination. Persons skilled in the art will, expediently, also consider the features individually and combine them to form appropriate, further combinations.

In the drawing:

FIG. 1 shows a hand power tool according to the invention, comprising a vibration absorber device fastened to a housing cover,

FIG. 2 shows a section through the hand power tool from FIG. 1,

FIG. 3 shows a housing cover and the vibration absorber device of the hand power tool from FIG. 1,

FIG. 4 shows a section (A-A) through the housing cover and the vibration absorber device,

FIG. 5 shows a partial section of the vibration absorber device of the hand power tool from FIG. 1, in a top view,

FIG. 6 shows a section (B-B) of the vibration absorber device of the hand power tool from FIG. 1, in a front view,

FIG. 7 shows the vibration absorber device of the hand power tool from FIG. 1, in a side view,

FIG. 8 shows a partial section of an alternative exemplary embodiment of the vibration absorber device from FIG. 1, comprising an absorber mass constructed from two mass parts,

FIG. 9 shows a section (C-C) of the vibration absorber device from FIG. 8, in a front view,

FIG. 10 shows a partial section (D-D) of the vibration absorber device from FIG. 8, in a side view,

FIG. 11 shows a further, alternative exemplary embodiment of the vibration absorber device from FIG. 1, comprising two holding parts, which are supported on each other,

FIG. 12 shows a section (E-E) of the vibration absorber device from FIG. 11, in a front view,

FIG. 13 shows a partial section of a further, alternative exemplary embodiment of the vibration absorber device from FIG. 1, comprising a spring receiver that is movable relative to the absorber mass, and

FIG. 14 shows a section (F-F) of the vibration absorber device of FIG. 13, in a front view.

### DESCRIPTION OF THE EXEMPLARY EMBODIMENTS

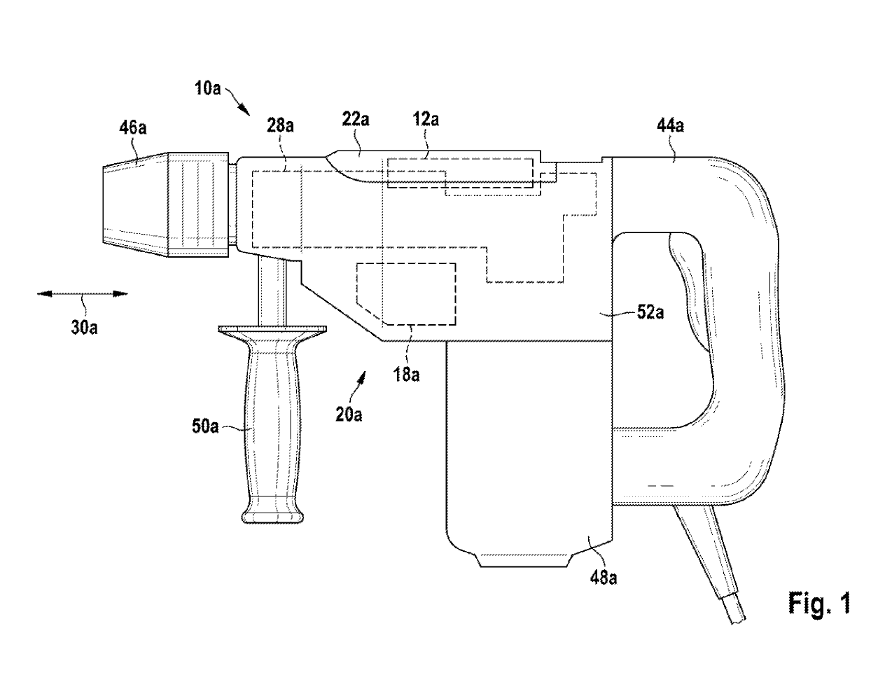

FIG. 1 shows a hand power tool 10a according to the invention, comprising a vibration absorber device 12a and a drive mechanism 18a, and comprising a mechanism housing 20a that has a metallic housing cover 22a. The hand power tool 10a is realized as a rotary and chipping hammer. The mechanism housing 20a encloses a chamber 24a, in which the drive mechanism 18a and the vibration absorber device 12a are disposed. Further, the hand power tool 10a has a main handle 44a, an insert tool fastening device 46a, a motor housing 48a and an auxiliary handle 50a. On a side of the mechanism housing 20a that faces away from the insert tool fastening device 46a, the main handle 44a is connected to the mechanism housing 20a and to the motor housing 48a. On a side that faces toward the insert tool fastening device 46a, the auxiliary handle 50a is connected to the mechanism housing 20a.

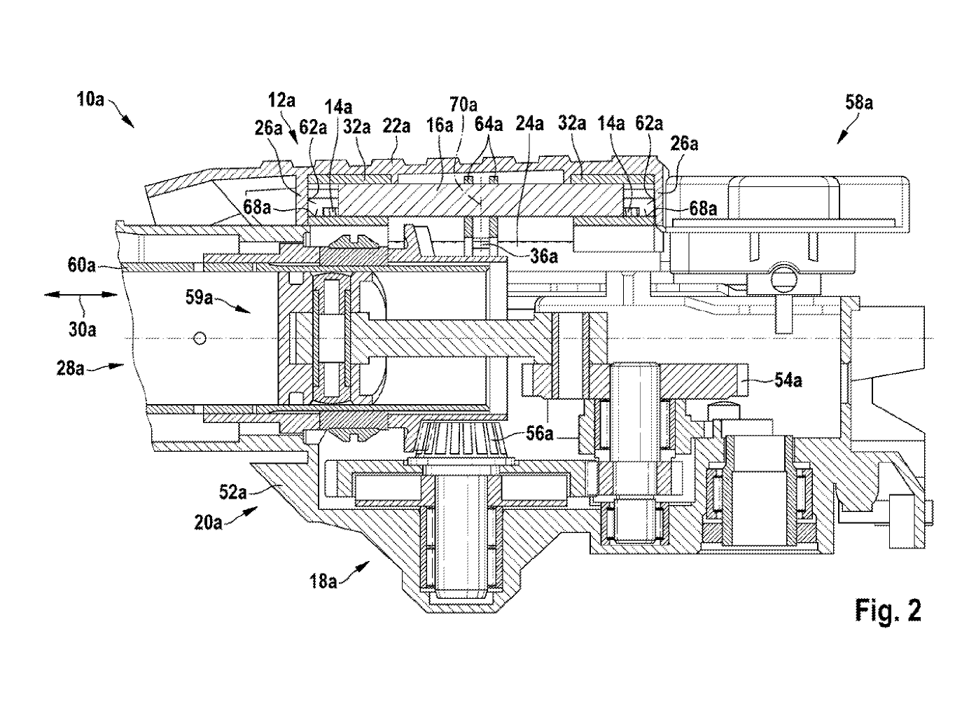

FIG. 2 shows a section through the mechanism housing 20a, which, besides the housing cover 22a, has a housing shell 52a. The vibration absorber device 12a and the drive mechanism 18a are disposed in the chamber 24a. The drive mechanism 18a has a percussion mechanism 28a, a first and a second transmission element 54a, 56a for rotary operation, and a switchover mechanism 58a. The percussion mechanism 28a is realized as a hammer percussion mechanism. The first transmission element 54a is additionally realized as an eccentric element of the percussion mechanism 28a. Furthermore, the percussion mechanism 28a has a piston 59a, a hammer tube 60a and, not represented in greater detail, a striker and a ram. The second transmission element 56a drives the hammer tube 60a in rotation. The rotary motion of the hammer tube 60a can be switched off by the switchover mechanism 58a in a manner considered appropriate by persons skilled in the art.

The housing cover 22a of the mechanism housing 20a is disposed on a side of the housing shell 52a that is opposite the motor housing 48a. It closes an assembly opening located there, and thus closes the chamber 24a. The hand power tool 10a has a seal, not represented in greater detail, which is disposed between the housing cover 22a and the housing shell 52a. The vibration absorber device 12a and the drive mechanism 18a are thereby protected against soiling. The chamber 24a is realized as a grease chamber, i.e. a common, permanent lubrication is provided in the chamber. The vibration absorber device 12a and the drive mechanism 18a are disposed in the chamber 24a closed by the housing cover 22a.

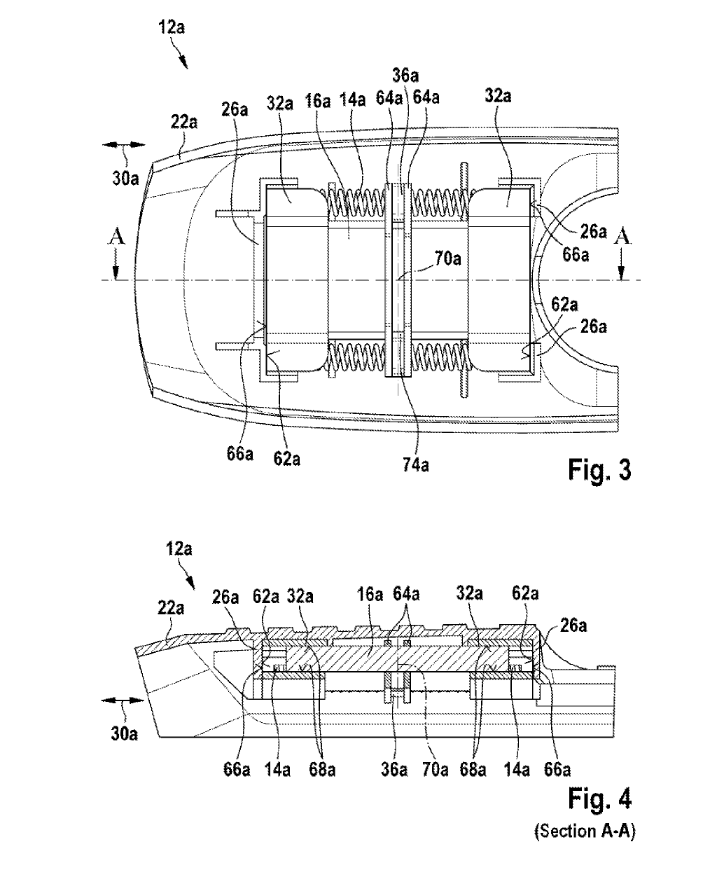

As shown by FIGS. 3 to 7, the housing cover 22a has three fastening means 26a. The fastening means 26a are realized as formed-on webs. The fastening means 26a have fastening surfaces 62a aligned perpendicularly in relation to a spring direction 30a. The fastening means 26a fasten after mounting of a structural unit, i.e. after the vibration absorber device 12a has been inserted in the cover, and during operation fasten the vibration absorber device 12a in the spring direction 30a. For this purpose, during a mounting operation the vibration absorber device 12a is compressed in the spring direction 30a and inserted in the housing cover 22a. As a result, through biasing in the spring direction 30a, absorber springs 14a of the vibration absorber device 12a effect a fastening force upon the housing cover 22a after mounting of a structural unit and during operation. The fastening force fastens the vibration absorber device 12a non-positively and perpendicularly in relation to the spring direction 30a, to the housing cover 22a. The vibration absorber device 12a and the housing cover 22a thus form a structural unit that can be preassembled, i.e. the vibration absorber device 12a and the housing cover 22a together, and separately from the housing shell 52a, form a unit that is stable per se.

After the housing cover 22a has been mounted on the housing shell 52a, the housing shell 52a effects a fastening force upon the vibration absorber device 12a, in a region not represented in greater detail. The fastening force acts perpendicularly in relation to the spring direction 30a. Alternatively or additionally, the vibration absorber device 12a could be latched, screwed, adhesive bonded and/or connected to the housing cover 22a in another manner considered appropriate by persons skilled in the art.

The percussion mechanism 28a and the vibration absorber device 12a are disposed partially on the same planes, which are aligned perpendicularly in relation to a spring direction 30a, i.e. the percussion mechanism 28a and the vibration absorber device 12a are disposed partially adjacently. A region of the vibration absorber device 12a that faces toward the insert tool fastening device 46a is disposed between the housing cover 22a and the percussion mechanism 28a. This region has no functional component apart from the vibration absorber device 12a.

The vibration absorber device 12a is realized so as to be mirror-symmetrical when in a non-operative state. It has the four absorber springs 14a, an absorber mass 16a, two holding parts 32a, two spring receivers 36a, and two spring receiver fastening devices 64a. The two holding parts 32a are realized as like parts, i.e. they have the same shape, but mirrored in relation to each other. In addition, the holding parts 32a have a slight oversize relative to the housing cover 22a. Outsides 66a of the holding parts 32a, which face toward or away from the insert tool fastening device 46a, fasten the vibration absorber device 12a in the housing cover 22a. The absorber springs 14a, the absorber mass 16a, the two spring receivers 36a and the two spring receiver fastening devices 64a are disposed between the holding parts 32a. The spring receivers 36a and the spring receiver fastening devices 64a are produced, at least partially, from plastic.

The holding parts 32a have guide surface 68a, which guide the absorber mass 16a in the spring direction 30a during operation. For this purpose, the holding parts 32a enclose the absorber mass 16a on a plane that is realized perpendicularly in relation to the spring direction 30a. In this exemplary embodiment, the holding parts 32a enclose the absorber mass 16a completely. Alternatively, the holding parts 32 could enclose the absorber mass 16a by more than 180 degrees. The holding parts 32a guide the absorber mass 16a on surfaces disposed farthest from a center of gravity 70a of the absorber mass 16a, enabling slight guiding forces and a slight friction to be achieved. Alternatively or additionally, a housing cover could also guide the absorber mass 16a and/or the absorber spring 14a. Furthermore, the holding parts 32a each have spring fastening devices 72a, which fasten the absorber springs 14a. For this purpose, the absorber springs 14a are screwed onto the spring fastening devices 72a.

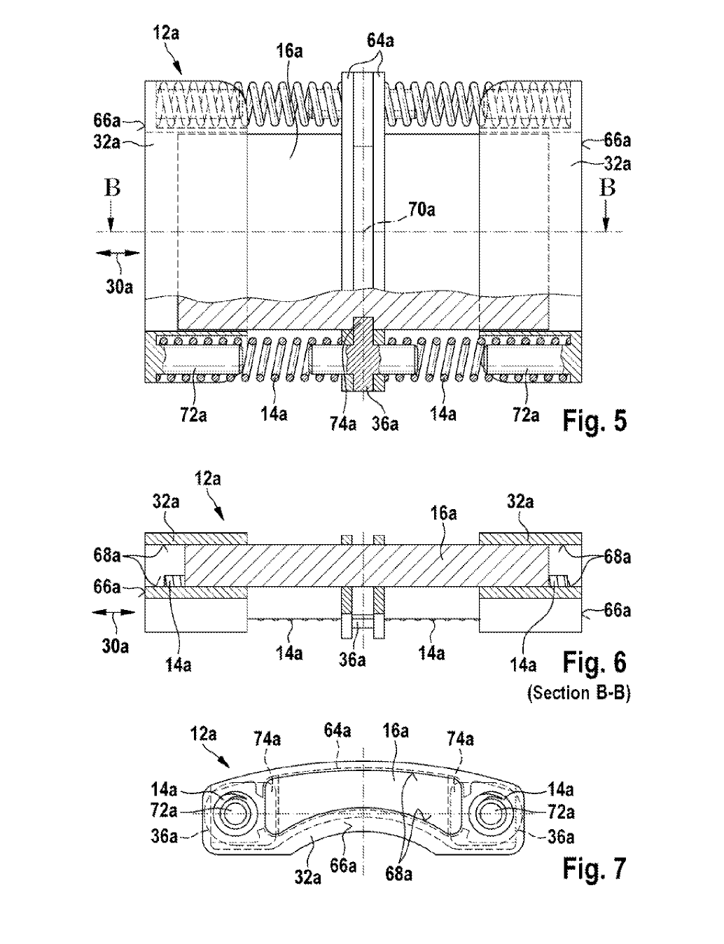

The four absorber springs 14a are each mechanically connected in a fixed manner on one side to the holding parts 32a, and on one side to the spring receivers 36a. The spring receivers 36a, as viewed perpendicularly in relation to the spring direction 30a, have a cross-shaped cross section (FIG. 5). On a side that faces toward the center of gravity 70a of the absorber mass 16a, the spring receivers 36a extend into recesses 74a of the absorber mass 16a. The spring receivers 36a in this case are supported on the absorber mass 16a. During a mounting operation, the spring receiver fastening devices 64a are pushed onto the absorber mass 16a and fix the spring receivers 36a, such that a positive connection is produced between the spring receivers 36a and the absorber mass 16a. The spring forces of the absorber springs 14a fasten the spring receiver fastening device 64a.

In addition, the vibration absorber device 12a could have damping elements, not represented in greater detail, which damp an impact of the absorber mass 16a on an end stop. For example, the damping elements could be disposed between the spring receivers 36a and the holding parts 32a inside the absorber springs 14a, in a guide of the holding parts 32a or on the housing cover 22a.

The absorber mass 16a has a homogeneous cross section in the spring direction 30a. The cross section is formed by means of a bar extrusion method. Absorber masses are cut off from a bar by a machine and, in the same working step, are provided with recesses for receiving spring receivers. Alternatively or additionally, an absorber mass could have a plurality of mass parts. Advantageously, at least one of the mass parts likewise has a homogeneous cross section. Particularly advantageously, at least one of the mass parts preferably has, for the most part, a standard cross section along at least one direction.

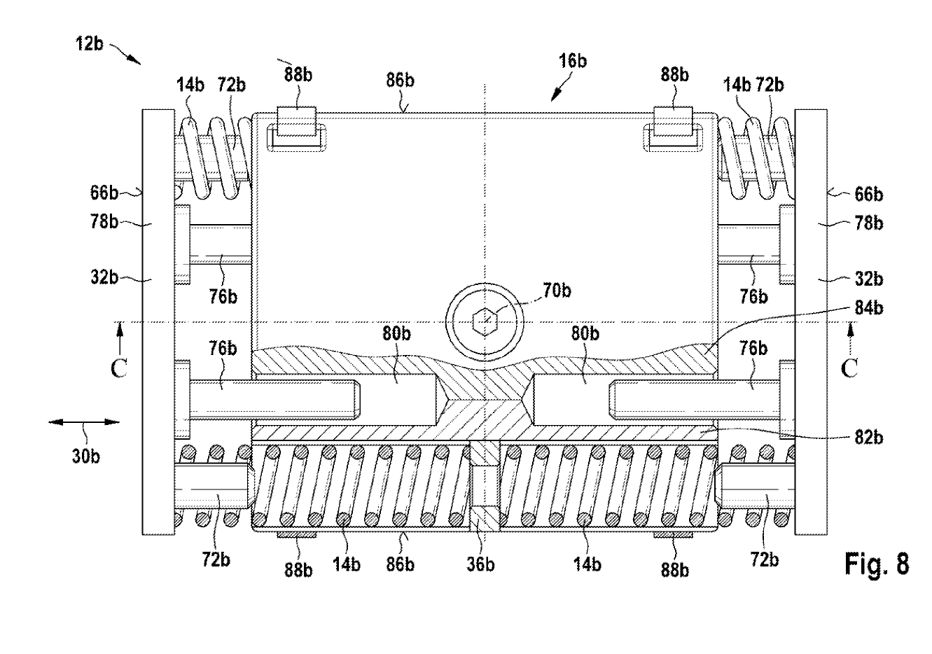

Three further exemplary embodiments of the invention are shown in FIGS. 8 to 14. To distinguish the exemplary embodiments, the letter a in the references of the exemplary embodiment in FIGS. 1 to 7 is replaced by the letters b to d in the references of the exemplary embodiments in FIGS. 8 to 14. The descriptions that follow are limited substantially to the differences between the exemplary embodiments and, in respect of components, features and functions that remain the same; reference may be made to the description of the other exemplary embodiments, in particular in FIGS. 1 to 7.

The exemplary embodiment of FIGS. 8 to 10 relates, as described in the exemplary embodiment of FIGS. 1 to 7, to a hand power tool 10b according to the invention, having a vibration absorber device 12b, represented in FIGS. 8 to 10, a drive mechanism 18b and a mechanism housing 20b having a housing cover 22b and a housing shell 52b. The housing cover 22b, when in a state of operational readiness, closes a chamber 24b, in which the drive mechanism 18b is disposed. The housing cover 22b has fastening means 26b that, in a state of operational readiness, fasten the vibration absorber device 12b.

The vibration absorber device 12b has four absorber springs 14b, an absorber mass 16b and two holding parts 32b. The holding parts 32b are realized as like parts. Each holding part 32b has two spring fastening devices 72b and two guide means 76b. The guide means 76b are realized as rods formed onto a base plate 78b of the holding parts 32b. The guide means 76b engage in recesses 80b of the absorber mass 16b and guide the latter in the spring direction 30b. Alternatively, guide means 76b could also extend fully through the absorber mass 16b in the spring direction 30b.

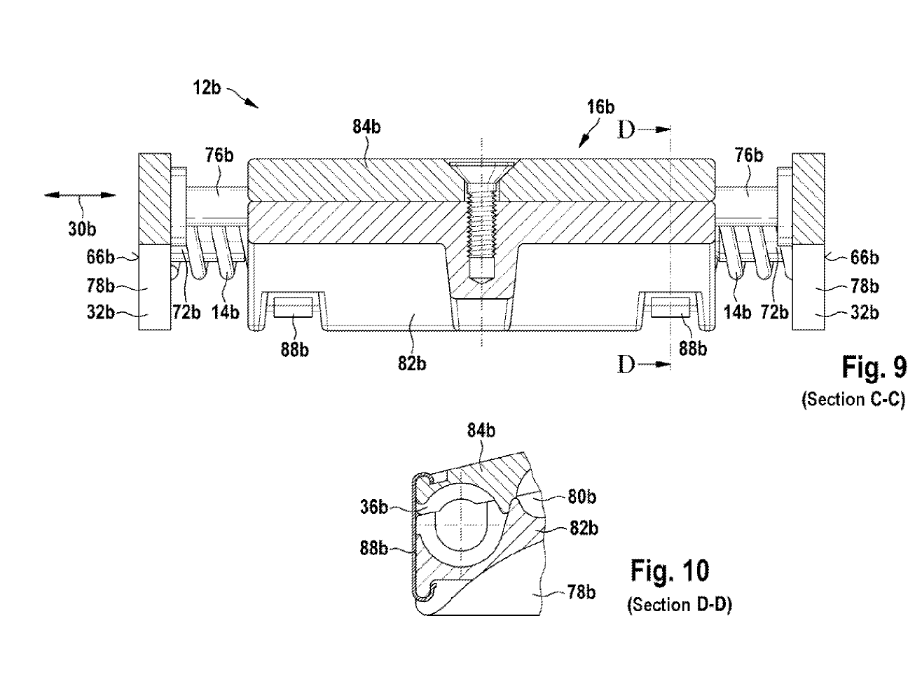

The absorber mass 16b has a first and a second mass part 82b, 84b. The first mass part 82b, which faces toward a percussion mechanism 28b and which is represented at the bottom in FIG. 9, is approximately as heavy as the second mass part 84b. In general, a heaviest mass part has a mass that, at most, is four times as great as a lightest mass part.

A division between the two mass parts 82b, 84b runs parallel to the spring direction 30b and substantially parallel to a main extent of the absorber mass 16b. Alternatively, a division could also be disposed perpendicularly in relation to a main extent of an absorber mass or perpendicularly in relation to the spring direction. The mass parts are screwed to each other in the center. In addition, the mass parts 82b, 84b are clamped to each other on outer sides 86b by latching hooks 88b. The absorber mass 16b encloses the absorber springs 14b by more than 180 degrees, in this example completely, on a plane aligned perpendicularly in relation to the spring direction 30b. In the enclosed regions, the absorber mass 16b guides the absorber springs 14b.

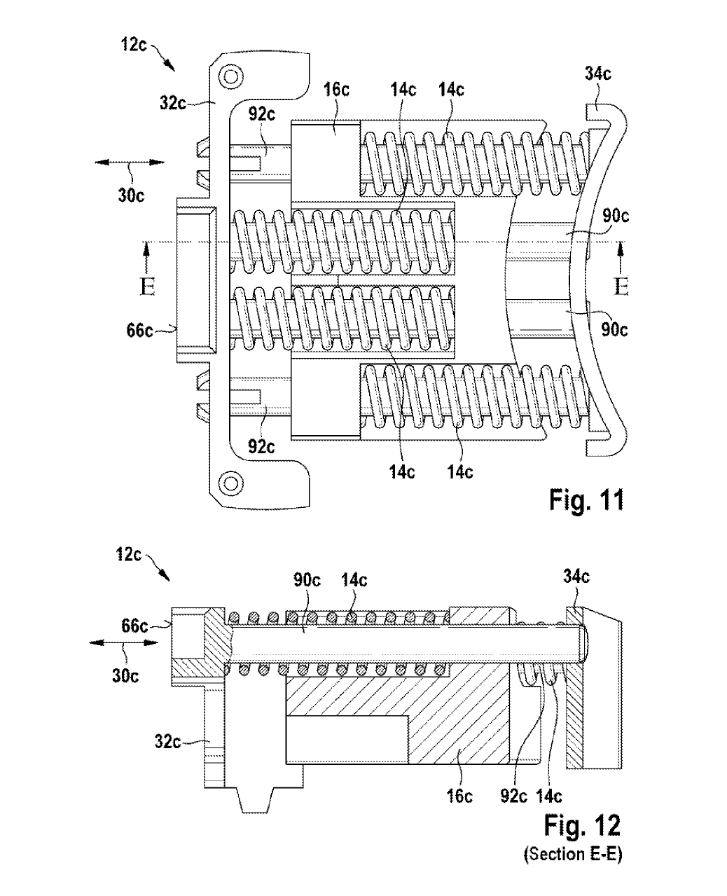

The exemplary embodiment of FIGS. 11 and 12 relates, as described in the exemplary embodiments of FIGS. 1 to 7, to a hand power tool 10c according to the invention, having a vibration absorber device 12c, represented in FIGS. 11 and 12, a drive mechanism 18c and a mechanism housing 20c having a housing cover 22c and a housing shell 52c. The housing cover 22c, when in a state of operational readiness, closes a chamber 24c, in which the drive mechanism 18c is disposed. The housing cover 22c has fastening means 26c that, in a state of operational readiness, fasten the vibration absorber device 12c.

The vibration absorber device 12c has a first and a second holding part 32c, 34c. The first holding part 32c is disposed facing toward an insert tool fastening device 46c. The second holding part 34c is disposed facing away from the insert tool fastening device 46c. The first holding part 32c and the second holding part 34c are supported against each other through the absorber springs 14c. For this purpose, the two holding parts 32c, 34c each have two rod-shaped formed-on elements 90c, 92c. The formed-on elements 90c of the first holding part 32c extend through two of the absorber springs 14c. In this case, the formed-on elements 90c guide the absorber springs 14c. Ends of the formed-on elements 90c, which face away from a base plate 78c of the first holding part 32c, are movably mounted in a recess, or bore, of the second holding part 34c. The formed-on elements 92c of the second holding part 34c likewise extend through and guide two of the absorber springs 14c. Ends of the formed-on elements 92c, which face away from a base plate 78c of the second holding part 34c, extend through a recess, or bore, of the first holding part 32c. On a side of the first holding part 32c that faces away from the base plate 78c of the second holding part 34c, the formed-on elements 92c are latched on the first holding part 32c. The vibration absorber device 12c thus has more than two guide rods 90c, 92c that guide the absorber mass 16c.

It can be seen from FIG. 12 that the outer absorber springs 14c are disposed somewhat deeper, i.e. closer to the drive mechanism 18c, than the inner absorber springs 14c. In addition, all, i.e. the four, absorber springs 14c are partially disposed on a plane that is aligned perpendicularly in relation to the spring direction 30c. As a result, the vibration absorber device 12c can be integrated into the housing cover 22cin a particularly space-saving manner. Furthermore, only one of the two holding parts 32c, 34c is mechanically connected to the mechanism housing 20c in a fixed manner.

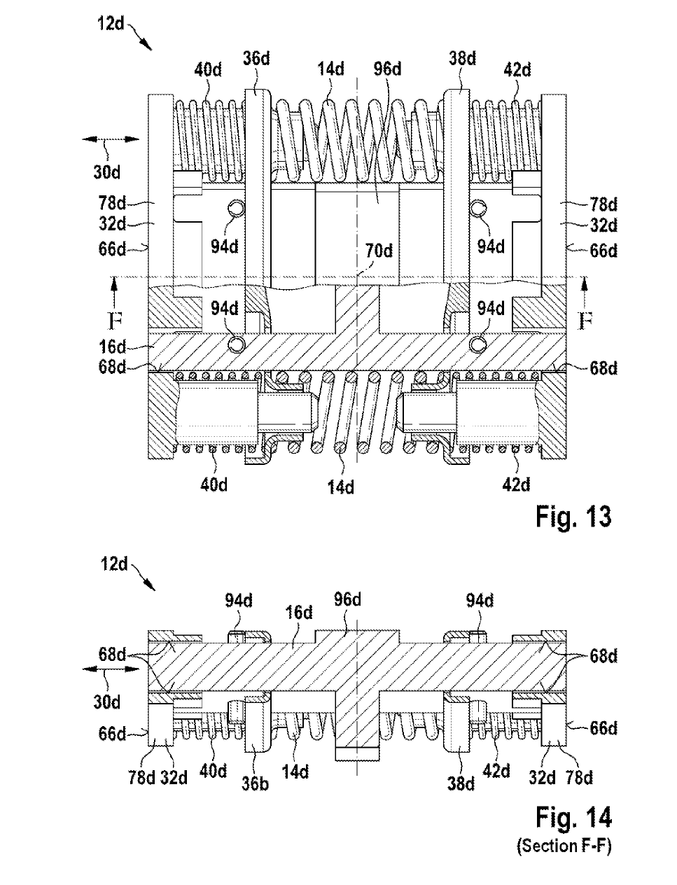

The exemplary embodiment of FIGS. 13 and 14 relates, as described in the exemplary embodiments of FIGS. 1 to 7, to a hand power tool 10d according to the invention, having a vibration absorber device 12d, represented in FIGS. 13 and 14, a drive mechanism 18d and a mechanism housing 20d having a housing cover 22d and a housing shell 52d. The housing cover 22d, when in a state of operational readiness, closes a chamber 24d, in which the drive mechanism 18d is disposed. The housing cover 22d has fastening means 26d that, in a state of operational readiness, fasten the vibration absorber device 12d.

The vibration absorber device 12d has two absorber springs 14d, an absorber mass 16d, a first and a second holding part 32d, a first and a second spring receiver 36d, 38d, and four support elements 40d, 42d. The holding parts 32d are pushed onto the absorber mass 16d. There, the holding parts 32d are secured with locking elements 94d. The locking elements 94d are realized as clamping sleeves, but could also be realized as other units considered appropriate by persons skilled in the art. The holding parts 32d are mounted on the absorber mass 16d so as to be movable in the spring direction 30d, this being between two locking elements 94d and a middle offset 96d in each case. The middle offset 96d extends perpendicularly in relation to the spring direction 30d.

The first holding part 32d and the first spring receiver 36d are disposed facing toward the insert tool fastening device 46d. The absorber mass 16d, when in an operating state, moves the second spring receiver 38d in the direction of the insert tool fastening device 46d. In this case, the second spring receiver 38d exerts an acceleration force upon the absorber mass 16d. The acceleration force brakes the absorber mass 16d. The second spring receiver 38d in this case transfers a motional energy of the absorber mass 16d to the absorber springs 14d, via the locking elements 94d. The absorber springs 14d buffer this energy. After the absorber springs 14d have arrested the absorber mass 16d relative to the holding parts 32d, the absorber springs 14d deliver the energy back to the absorber mass 16d and, in so doing, accelerate the absorber mass 16d. In this movement of the absorber mass 16d from a central position in the direction of the insert tool fastening device 46d, the first spring receiver 36d supports a counter force of the acceleration force at the first holding part 32d. After the absorber mass 16d has crossed over a central position, the same operation is effected, in a mirror inverted manner, in the opposite direction.

The support elements 40d, 42d in two differing operating states press the spring receivers 36d, 38d against the absorber springs 14d. The support elements 40d, 42d are realized as support springs. A force of the support elements 40d, 42d in this case is significantly less than the acceleration force of the absorber springs 14d. The support elements 40d, 42d in this case are aligned coaxially in relation to the absorber springs 14d. The absorber springs 14d are disposed entirely in an axial region, i.e. laterally next to the absorber mass 16d.

1. A hand power tool comprising:
at least one vibration absorber device which has at least one absorber spring and an absorber mass, and comprising
a drive mechanism, and
a mechanism housing having (i) a housing cover that is provided configured to close a chamber in which the drive mechanism is disposed, and (ii) at least one fastening mechanism configured to, in at least one operating state, at least partially fasten the at least one vibration absorber device.

2. The hand power tool as claimed in claim 1, wherein the at least one vibration absorber device and the drive mechanism are disposed in the chamber closed by the housing cover.

3. The hand power tool as claimed in claim 1, wherein the housing cover and the at least one vibration absorber device constitute a structural unit configured to that can be preassembled.

4. The hand power tool as claimed in claim 1, wherein the at least one absorber spring is configured to, in at least one operating state, effect a fastening force upon the housing cover.

5. The hand power tool as claimed in claim 1, wherein:
the at least one absorber spring defines a spring direction,
the drive mechanism has a percussion mechanism, wherein and
the percussion mechanism and the at least one vibration absorber device are at least partially disposed on at least one same plane that is aligned perpendicularly in relation to a the spring direction.

6. The hand power tool as claimed in claim 1, wherein:
the at least one vibration absorber device has at least one first holding part and one second holding part, wherein and
the first holding part and the second holding part are supported against each other through the at least one absorber spring.

7. The hand power tool as claimed in claim 1, wherein the at least one vibration absorber device has at least one holding part and has at least one spring receiver that, in at least one operating state, exerts an acceleration force upon the absorber mass and, in at least one operating state, supports a counter force of the acceleration force on the at least one holding part.

8. The hand power tool as claimed in claim 7, wherein the at least one vibration absorber device has at least one support element that is configured to, in at least one operating state, press the spring receiver against the absorber spring.

9. The hand power tool as claimed in claim 1, wherein the at least one absorber spring is disposed entirely in an axial region of the absorber mass.

10. (canceled)
